(19) United States
(12) Patent Application Publication
(10) Pub. No.: US 2021/0312520 A1
(43) Pub. Date: Oct. 7, 2021

(54) MULTI-PARTY NEGOTIATION IN AN ONLINE MARKETPLACE

(71) Applicant: eBay Inc., San Jose, CA (US)

(72) Inventor: Vikas Singh, San Jose, CA (US)

(21) Appl. No.: 16/836,975

(22) Filed: Apr. 1, 2020

(51) Int. Cl. G06Q 30/06; G06Q 30/02

(52) U.S. Cl. CPC G06Q 30/0629; G06Q 30/0619; G06Q 30/0283

(57) ABSTRACT

Disclosed are systems, methods, and non-transitory computer-readable media for a multi-party negotiation system in an online marketplace. A negotiation system determines that a total value for an item listing is greater than a target value for the item listing. The total value includes a portion that is allocated to a service provider providing a service related to the item listing. The negotiation system transmits a query to the service provider requesting that the service provider provide the service for a reduced value. In response to receiving an acknowledgement that the service provider has agreed to provide the service for the reduced value, the negotiations system generates an updated total value for the item listing based on the reduced value that is no greater than the target value.

### TECHNICAL FIELD

An embodiment of the present subject matter relates generally to an online marketplace and, more specifically, to multi-party negotiation in an online marketplace.

### BACKGROUND

Online marketplace services allow users to buy and sell items. For example, these services enable users to post listings offering items for sale, as well as view listings posted by other users. The sale price collected for an item sold on an online marketplace is split between multiple parties, including the seller, the online marketplace and one or more service that provide services in relation the sale, such as a shipping logistic service and/or payment processing service. Online marketplace services manage the relationship with the service providers, meaning that the seller has no access to these parties. As a result, a seller's ability to reduce the sale price of a listed item is limited to reducing their share of the sale price. This reduces the number of sales as sometimes sellers cannot meet or beat a competitor price and remain profitable, even if the sale price is very close in value to the competitor price. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for multi-party negotiation in an online marketplace, according to some example embodiments.

FIG. 2 is a block diagram of the multi-party negotiation system, according to some example embodiments.

FIG. 3 is a block diagram of a negotiation triggering module 202, according to some example embodiments.

FIG. 4 is a block diagram of a negotiation management module, according to some example embodiments.

FIGS. 5A-5C show examples of queries transmitted to service providers, according to some example embodiments.

FIG. 6 is a flowchart showing a method of multi-party negotiation in an online marketplace, according to some example embodiments.

FIG. 7 is a flowchart showing a method of multi-party negotiation in an online marketplace, according to some example embodiments.

FIG. 8 is a block diagram illustrating a representative software architecture, which may be used in conjunction with various hardware architectures herein described.

FIG. 9 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for multi-party negotiation in an online marketplace. An online marketplace service allows users to buy and sell items online. For example, the online marketplace service allows users to post a listing to an online marketplace that lists an item for sale. The total value (e.g., sale price) collected for an item sold on the online marketplace is split between multiple parties, including the seller, the online marketplace service and one or more service providers that provide services in relation to facilitating the sale, such as a shipping logistic service (e.g., shipping and handling) and/or payment processing service handling (e.g., payment management). Currently, online marketplace services manage the relationship with the service providers, meaning that the seller has no access to these parties. As a result, a seller's ability to reduce the total value of a listed item is limited to reducing the portion of the total value that is allocated to the seller. This reduces the number of sales as sometimes sellers cannot meet or beat a competitor price and remain profitable, even if the sale price is very close in value to the competitor price.

To alleviate these issues, a multi-party negotiation system facilitates negotiations with the service providers to provide a reduced total value (e.g., reduced sale price) for an item listing. For example, the multi-party negotiation system may determine reduced values to be allocated for services provided in relation to the item listing that, if accepted by the services providers, would allow the total value (e.g., sale price) of the item listing to be reduced to or below a target value. The multi-party negotiation system transmits queries to the service providers requesting that each service provider provide their respective service for the reduced value, which the service providers may select to accept or deny.

In the event that the queried service providers agree to provide the services for the reduced values, the multi-party negotiation system may generate a reduced total value for the item listing based on the reduced values. For example, the portion of the reduced total value that is allocated to each service provider is based on the reduced value to which the service provider agreed to provide their corresponding service, thereby allowing the total value to be reduced without further reduction to the portion allocated to the seller.

In some cases, only a single service provider may be available to provide a particular service in relation to an item listing. For example, an online marketplace service may have an existing relationship with a single service provider to provide the particular service, such as providing payment processing services for the items listing posted to the online marketplace. In this type of embodiment, the multi-party negotiation system may query the single service provider regarding accepting a reduced value to provide their service in relation to an item listing.

In some embodiments, multiple service providers may be available to provide a particular service in relation to an item listing. For example, an online marketplace service may have an existing relationship with multiple service providers or allow any service provider to provide the particular service, such as payment processing, for the item listing posted to the online marketplace. Accordingly, the multi-party negotiation system may query multiple service providers regarding providing the service for the reduced value. In this type of embodiment, the multi-party negotiation system may select the first service provider that accepts providing the service for the reduced value or, alternatively, select the service provider that agrees to provide the service for the lowest value.

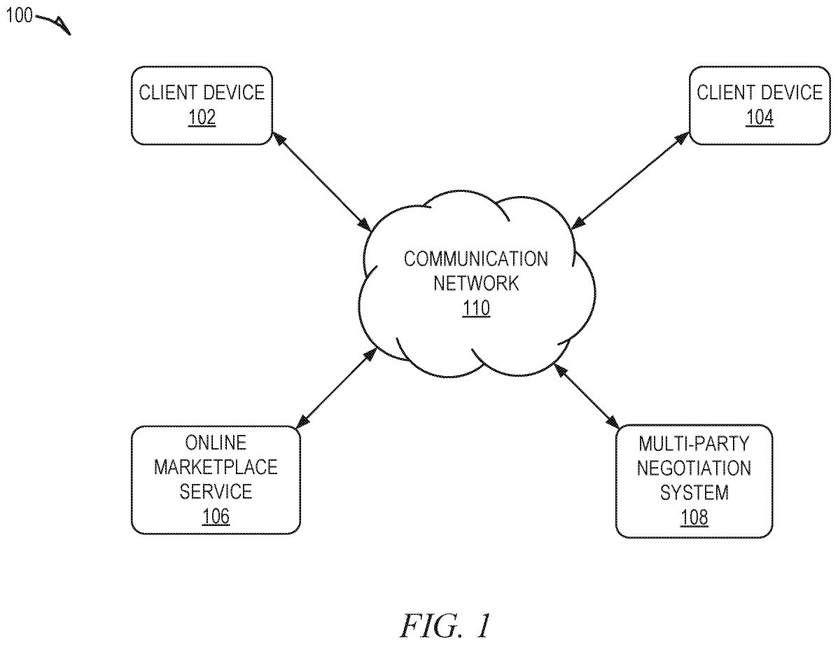

FIG. 1 shows a system 100 for multi-party negotiation in an online marketplace, according to some example embodiments. As shown, multiple devices (i.e., client device 102, client device 104, online marketplace service 106, and multi-party negotiation system 108) are connected to a communication network 110 and configured to communicate with each other through use of the communication network 110. The communication network 110 is any type of network, including a local area network (LAN), such as an intranet, a wide area network (WAN), such as the internes, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

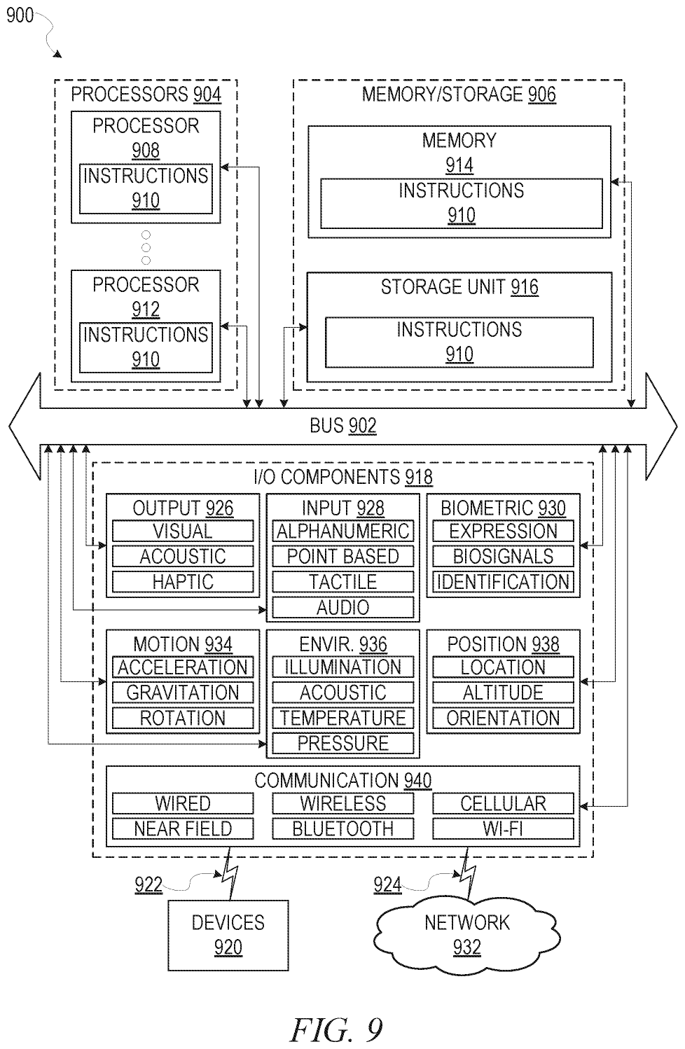

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 900 shown in FIG. 9.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online marketplace service 106 to utilize the services provided by the online marketplace service 106. The online marketplace service 106 provides an online marketplace in which users may post items for sale and purchase items posted for sale by other users. For example, the online marketplace service 160 may include items being auctioned for sale and/or items listed for sale at a set price. Users communicate with and utilize the functionality of the online marketplace service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online marketplace service 106 may concurrently accept connections from and interact with any number of client devices 102, 104. The online marketplace service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online marketplace service 106 via a client-side application installed on the client devices 102 and 104. In some embodiments, the client-side application includes a component specific to the online marketplace service 106. For example, the component may be a stand-alone application, one or more application plug-ins, and/or a browser extension. However, the users may also interact with the online marketplace service 106 via a third-party application, such as a web browser, that resides on the client devices 102 and 104 and is configured to communicate with the online marketplace service 106. In either case, the client-side application presents a user interface (UI) for the user to interact with the online marketplace service 106. For example, the user interacts with the online marketplace service 106 via a client-side application integrated with the file system or via a webpage displayed using a web browser application.

The online marketplace service 106 is one or more computing devices configured to facilitate an online marketplace (e.g., EBAY, AMAZON, etc.) in which users may post items for sale and purchase items posted for sale by other users. For example, the online marketplace service 106 provides a user interface that enables users to view listings posted to the online marketplace service 106. Each listing provides details for an item or items listed for sale. For example, the listing may include an item description, images, sale price, current bid price, auction time remaining, shipping options, aspects, etc.

The online marketplace service 106 may further provide functionality that enables a user to purchase and/or bid on an item listed for sale. For example, the online marketplace service 106 may provide user interface elements (e.g., button, text fields, etc.) that a user may use to select to purchase an item, place a bid, etc., as well as provide their financial (e.g., credit card number, bank account number) and personal information (e.g., shipping address, billing address, etc.) to complete the purchase.

To list an item for sale on the online marketplace, a user creates a user account with the online marketplace service 106. The user account may include the user's personal information (e.g., name, address, email address, phone number, etc.) and financial information (e.g., credit card information, bank account information, etc.). Once the user has created a user account, the user may then use their user account to utilize the functionality of the online marketplace service 106, including listing an item for sale on the online marketplace.

The online marketplace service 106 provides users with a listing interface that enables a user to create a new listing as well as provide data for the listing. For example, the listing interface may include data fields that prompt the user to provide specified information for the listing, such as the total value (e.g., sale price), item description, listing title, images, shipping cost, return policy, aspects, etc. The listing interface may also include user interface elements, such as buttons, that enable the user to submit and/or post a completed listing. That is, the user may post the listing after the user has filled in the data fields and provided images included in the listing interface.

The total value assigned to an item listing is a monetary value (e.g., sale price) that is paid by a user to purchase the item offered for sale by the item listing. Portions of the total value are allocated to be paid to various parties related to the sale of the listed item. For example, portions of the total value may be allocated to the seller that posted the item listing, the online marketplace service 106 (e.g., marketplace management), and one or more service providers that provide services in relation to completing the sale of the item, such as a shipping logistic provider, a payment processing provider, and the like.

One issue with current systems is that sellers are not able to communicate with service providers, as this relationship is generally managed by an online marketplace. This can be problematic in situations in which a seller wishes to reduce the total value assigned to an item listing as the seller may only reduce the portion of the total value that is allocated to the seller. That is, the seller has no way of communicating with and/or negotiating with the service providers to reduce the portions of the total value that are allocated to the service providers. This limits the amount by which the seller may reduce the total value for an item while remaining profitable. As a result, sellers may sometimes be unable to meet a competitor price, even if the total value is very close in value to the competitor price, which ultimately reduces the number of sales.

To alleviate these issues, the online marketplace service 106 utilizes the multi-party negotiation system 108 to facilitate negotiations with service providers to reduce the total value for an item listing based on a target value. Although the multi-party negotiation system 108 and the online marketplace 106 are shown as separate entities, this is just for ease of explanation and is not meant to be limiting. In some embodiments, the multi-party negotiation system 108 is incorporated as part of the online marketplace service 106.

The target value is a value that is less than the total value for the item listing. The target value may be based on a competitor price for the item, an offered price provided by a user of the online marketplace service 106, and the like. For example, the target value may be the competitor price or a value below the competitor price. As another example, the target value may be the offered price provided by a user or a price that is above the offered price, but below the currently total value assigned to the item listing.

To reach the target value, the multi-party negotiation system 108 negotiates with service providers to reduce the portion of the total value to be allocated to the service providers for providing services in relation to the item listing. By reducing the portions allocated to the service providers, the multi-party negotiation system 108 can reduce the total value without reducing the portion of the total value allocated to the seller. That is, the portion of the reduced total value allocated to the seller will be the same (e.g., remain unchanged) as the portion of the original total value that was allocated to the seller.

The multi-party negotiation system 108 determines reduced values (e.g., reduced portions of the total value) to be allocated to service providers for providing services in relation to the item listing based on the target value. For example, the multi-party negotiation system 108 determines reduced values that, if accepted by the services providers, allows the multi-party negotiation system 108 to reduce the total value (e.g., sale price) of the item listing to the target value without reducing the portion of the total value allocated to the seller. As an example, an item listing may be assigned a total value of $10 where $6 is allocated to the seller and $4 is allocated to a service provider. If the service provider agrees to accept a reduced value of $3 for providing their service, the multi-party negotiation system 108 may reduce the total value to $9 without reducing the portion of the final price allocated to the seller. That is, the portion allocated to the seller remains at $6, while the portion allocated to the service provider is reduced to $3.

The multi-party negotiation system 108 transmits queries to the service providers requesting that each service provider provide their respective service for the reduced value, which the services providers may accept or deny. For example, the multi-party negotiation system 108 may transmit queries to client devices 102, 104 associated with the service providers. A query may be any type of communication message, such as an email, text message, Short Message Service (SMS) message, in-app message, and the like. A query may identify the reduced value and/or prompt the service provider to enter a reduced value which the service provider is willing to accept to provide the service. Further, a query may enable the service provider to accept or deny the request, such as by including user interface elements which the service provider may select to choose from either option. For example, the service provider may select to accept the request, indicating that the service provider is willing to provide the service for the reduced value. Alternatively, the service provider may select to deny the request, indicating that the service provider is not willing to provide the service for the reduced value. In some embodiments, the query may enable a service provider to provide a counteroffer, such as by entering an alternate reduced value that the service provider is willing to accept (e.g., an alternate reduced value that is higher than the reduced value included in the query).

In the event that the service providers agree to accept the reduced values, the multi-party negotiation system 108 may generate a reduced total value for the item listing. The portions of the reduced total value that are allocated to the service providers are based on the reduced values accepted by the service providers. Accordingly, the portion of the reduced total value allocated to each service provider is lower than the portion allocated to the service provider in the original total value, while the portion of the reduced total value that is allocated to the seller remains the same as from the original total value.

In some cases, only a single service provider may be available to provide a particular service in relation to an item listing. For example, an online marketplace service 106 may have an existing relationship with a single service provider to provide a particular service (e.g., payment processing, shipping logistics) for the items listing posted to the online marketplace. In this type of embodiment, the multi-party negotiation system 108 may query the single service provider regarding accepting a reduced value to provide their service in relation to an item listing.

In other embodiments, however, multiple service providers may be available to provide a particular service in relation to an item listing. For example, an online marketplace service 106 may have an existing relationship with multiple service providers or allow for use of different service providers to provide one or more of the services (e.g., payment processing, shipping logistics) for the item listings posted to the online marketplace. Accordingly, the multi-party negotiation system 108 may query multiple service providers regarding providing the service for the reduced value. In this type of embodiment, the multi-party negotiation system 108 may select the first service provider that accepts the reduced value to provide the service or a service provider that offers to provide the service for the lowest value.

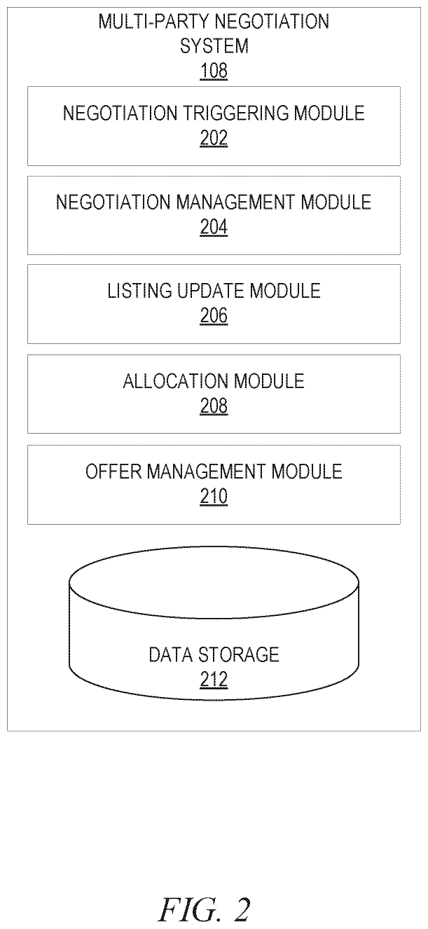

FIG. 2 is a block diagram of the multi-party negotiation system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the multi-party negotiation system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the multi-party negotiation system 108 and the online marketplace service 106.

As shown, the multi-party negotiation system 108 includes a negotiation triggering module 202, a negotiation management module 204, a listing update module 206, an allocation module 208, an offer management module 210, and a data storage 212.

The negotiation triggering module 202 determines whether to perform a multi-party negotiation in relation to an item listing. A multi-party negotiation may be reserved for use in situations in which a seller is no longer willing or able to reduce the portion of the total value that is allocated to the seller for an item listing and/or the total value is slightly above a target price (e.g., price offered by a user, a competitor price for a similar item). In these types of situations, the multi-party negotiation system 108 may facilitate a multi-party negotiation process to reduce the total value for the item listing by reducing the portions of the total value that are allocated to the service providers.

The negotiation triggering module 202 determines when to perform a multi-party negotiation based on one or more sets of triggering conditions. Each set of triggering conditions defines a group one or more individual triggering conditions that, if satisfied, trigger performance of a multi-party negotiation in relation to an item listing. Accordingly, the negotiation triggering module 202 determines whether a set of triggering conditions has been satisfied in relation to an item listing and, if so, initiates a multi-party negotiation in relation to the item listing. For example, the negotiation triggering module 202 may instruct the other modules of the multi-party negotiation system 108 to initiation a multi-party negotiation.

The individual triggering conditions may be any of a variety of types of conditions and based on a variety of factors. For example, an individual triggering condition may be based on performance of a specified event or action, such as a seller rejecting of an offer submitted for an item listing, a user submitting an offer that is below a floor value associated with an item listing, and the like. As another example, an individual triggering condition may be identifying a lower competitor price for the same or similar item. As another example, an individual triggering condition may be receiving a request from a seller to perform a multi-party negotiation in relation to an item listing.

An individual triggering condition may also be based on the portion of the total value that is allocated to the seller. For example, an individual triggering condition may be based on the portion of the total value allocated to the seller being reduced by the seller at least a threshold amount from an original value and/or the portion of the total value allocated to the seller being within a threshold amount of a cost value for the item. This type of condition may ensure that the seller has adequately exhausted their ability to reduce the target value prior to initiation of a multi-party negotiation.

In some embodiments, an individual triggering condition may be based on a variance between the total value and a target value. For example, the individual triggering condition may be based on the total value being within a threshold amount of a target value. The threshold amount may be based on an amount by which the total value can be further reduced through a multi-party negotiation. For example, the threshold amount may be based on a percentage of the portions that are allocated to the service provides. This type condition ensures that the final price can be reduced to or near a target price by performing a multi-party negotiation. In other words, the multi-party negotiation system 108 will not perform a multi-party negotiation in situations in which the final price is unlikely to be reduced to or near a target value.

These are just some examples of possible individual triggering conditions and are not meant to be limiting. Further, each set of triggering conditions may include any number of individual triggering conditions. For example, a set of triggering conditions may include the individual conditions that the seller rejected an offer, the portion of the total value allocated to the seller is within a threshold amount of a cost value for the item, and the total value is within a threshold value of the bid amount of the rejected offer. Accordingly, the set of triggering conditions is not satisfied unless each of the individual conditions is met.

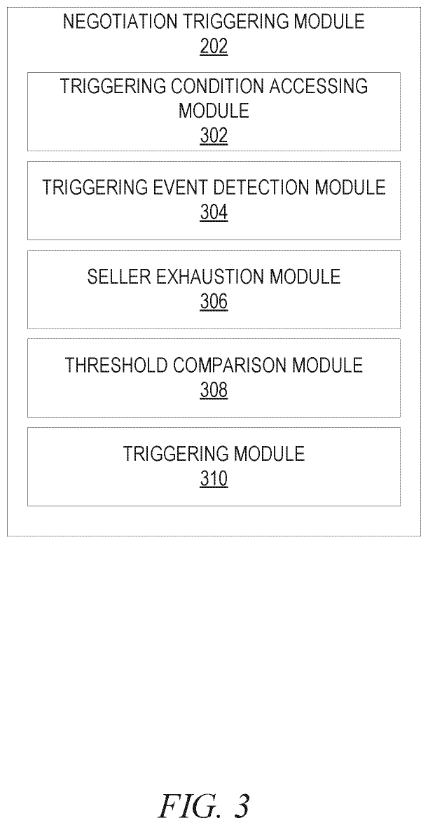

The negotiation triggering module 202 monitors and/or receives data to determine whether a set of triggering conditions has been satisfied. The sets of triggering conditions may be stored in the data storage 212, from which they may be accessed by the negotiation triggering module 202. In the event that the negotiation triggering module 202 determines that a set of triggering conditions has been satisfied, the negotiation triggering module 202 may instruct the other modules of the multi-party negotiation system 108 to initiate a multi-party negotiation in relation to the item listing. The functionality of the negotiation triggering module 202 is described in greater detail below in relation to FIG. 3.

The negotiation management module 204 manages the multi-party negotiation process for a listing. For example, the negotiation management module 204 queries service providers to provide a service for a reduced value. This may include identifying the service providers that can provide the services in relation to the listing, determining the reduced values to be requested from the service provider, and/or querying the service providers to submit a bid indicating a reduced value at which the service provider is willing to provide the service.

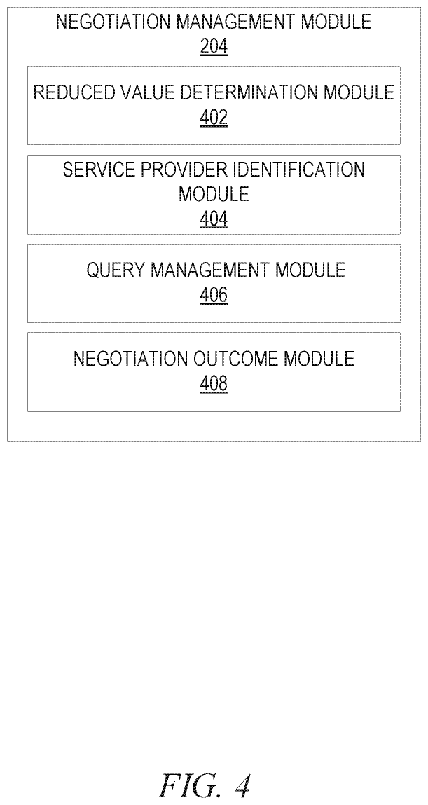

The negotiation management module 204 further manages receiving responses to the queries, determining whether that final price can be reduced to a target value and/or within a threshold amount of a target value based on the responses, and/or facilitating follow up queries if needed. In the event that the negotiation management module 204 is able to successfully negotiate reduced values for performance of services for an item listing, the negotiation management module 204 determines a reduced total value for the item listing based on the reduced values accepted by the service providers. For example, the portions of the reduced total value allocated to each service provider is based on the reduced value at which the service provider agreed to provide the service. The functionality of the negotiation management module 204 is discussed in greater detail below in relation to FIG. 4.

The listing update module 206 updates a listing based on a reduced total value. For example, the listing update module 206 communicates with the online marketplace service 106 to indicate that the multi-party negotiation system 108 was successful in negotiating a reduced total value for the listing. In turn, the online marketplace service 106 may update the item listing to reflect the reduced total value. In some embodiments, the listing update module 206 may update the item listing directly. For example, in embodiments in which the multi-party negotiation system 108 is incorporated as part of the online marketplace service 106, the listing update module 206 may have access to update the item listings. In this type of embodiment, the data defining the item listings may be stored in the data storage 212. The listing update module 206 may communicate with the data storage to identify the corresponding item listing and update the item listing based on the reduced total value.

The allocation module 208 updates the portions of the total value that are allocated to the various parties, such as the seller, online marketplace service 106 and service providers. For example, the allocation module 208 may transmit data to the online marketplace service 106 that identifies the portions of the reduced total value that are to be allocated to each party. This may include identifying the reduced values agreed to by the service providers for providing services in relation to an item listing. In turn, the online marketplace service 106 may update its records to reflect the portions of the total value to be allocated to each party. Alternatively, the allocation module 208 may update the records directly, such as in embodiments in which the multi-party negotiation system 108 is incorporated as part of the online marketplace service 106. For example, the allocation module 208 may update records in the data storage 212 to reflect the portions of the reduced total value to be allocated to each party.

The offer management module 210 manages offers based on a reduced total value. As explained previously, the multi-negotiation process may be performed in response to actions associated with an offer being submitted for an item listing, such as a seller rejecting a submitted offer or a user submitting an offer that is below a floor value associated with the item listing (e.g., below a cost value, below an lowest accepted offer value). In these types of cases, the reduced total value may be used to respond to the offer, such as by accepting the submitted offer or presenting a counteroffer. The offer management module 210 manages the process of using the reduced total value in relation to a submitted offer. For example, the offer management module 210 may present a notification to a seller indicating that the multi-party negotiation system 108 was able to reduce the total value without affecting the portion allocated to the seller by negotiation reduced values allocated to the service providers. This allows the seller to accept a lower offer and/or provide a counteroffer that is lower than the seller would typically offer.

The notification provided to the seller may be presented on a user interface provided by the online marketplace service 106 and/or sent as a message, such as an email, SMS, text, and the like. Further, the notification may enable the user to accept a submitted offer and/or transmit a counteroffer. The offer management module 210 communicates with the online marketplace service 106 to cause an offer to be accepted and/or a counteroffer to be transmitted based on a seller's response.

FIG. 3 is a block diagram of a negotiation triggering module 202, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the negotiation triggering module 202 to facilitate additional functionality that is not specifically described herein. Furthermore, the various functional modules depicted in FIG. 3 may reside on a single computing device or may be distributed across several computing devices in various arrangements such as those used in cloud-based architectures.

As shown, the negotiation triggering module 202 includes a triggering condition accessing module 302, a triggering event detection module 304, a seller exhaustion module 306, a threshold comparison module 308, and a triggering module 310.

The triggering condition accessing module 302 accesses sets of triggering conditions from the data storage 212. As explained above, each set of triggering conditions defines a group one or more individual triggering conditions that, if satisfied, triggers performance of a multi-party negotiation in relation to an item listing. The individual triggering conditions may be of a variety of types, including conditions based on occurrence of specified events, a valiance between the portion of the total value allocated to the seller and a cost value associated with an item, a variance between the total value and a target value, and the like. The triggering condition accessing module 302 provides the set of triggering conditions to the other modules of the negotiation triggering module 202 for use in determining whether a set of triggering conditions have been satisfied.

The triggering event detection module 304 determines whether an event-based trigger has occurred. An event-based trigger is a condition based on occurrence of an event. Examples of event-based triggers include a seller rejecting of an offer submitted for an item listing, a user submitting an offer that is below a floor value associated with an item listing, identifying a lower competitor price for the same or similar item, receiving a request from a seller to perform a multi-party negotiation in relation to an item listing, and the like.

These types of event-based triggers may be implemented as a gateway condition for performing a multi-party negotiation in relation to an item listing. That is, determination of whether the other triggering conditions in a set of triggering conditions is satisfied may be conditional upon satisfaction of an event-based condition. For example, triggering conditions such as determining whether the portion of the final price allocated to the sale price is within a threshold amount of a cost value for the item and/or determining whether the total value is within a threshold amount of a target value may be conditioned upon occurrence of specified events, such as the seller rejecting an offer or the seller requesting that the multi-party negotiation be performed. Accordingly, if the event-based trigger is determined to be satisfied (e.g., a seller rejected an offer, a lower competitor price is identified), the negotiation triggering module 202 may then determine whether the other associated individual triggering conditions are also satisfied.

The triggering event detection module 304 may determine whether an event-based condition related to an offer has occurred based on notifications received from an online marketplace service 106 and/or by accessing offer data. For example, the triggering event detection module 304 receive notifications from the online marketplace service 106 indicating that specified events have occurred, such as an offer being rejected by a seller, an offer being submitted, and the like. The triggering event detection module 304 may access offer data stored in the data storage 212 and/or by the online marketplace service 106. The offer data may include data describing offer activity in relation to item listings posted to the online marketplace service 106. For example, the offer data may indicate offers that were submitted for listings, the offered price, whether a seller accepted or rejected the offer, and the like. Accordingly, the triggering event detection module 304 may analyze the offer data to determine whether an event-based condition has been satisfied.

The triggering event detection module 304 may determine whether an event-based condition related to a competitor price has occurred based on monitoring competitor websites and/or by receiving notifications indicating that a lower price has been identified. For example, the triggering event detection module 304 may periodically check competitor websites for listed prices related to specified items and identify competitor prices for items listed on the online marketplace. This may include identifying a set of competitor prices for an item or a single lowest competitor price for an item. The triggering event detection module 304 may store this gathered competitor price data in the data storage 212. The triggering event detection module 304 may use the stored data to determine whether any competitor prices are below the final value associated with a listing posted to the online marketplace.

The triggering event detection module 304 may also receive notifications indicating that a seller has requested that a multi-party negotiation be performed in relation to an item listing. For example, the online marketplace service 106 may enable sellers to request that a multi-party negotiation be initiated in relation to a listing posted by the seller, such as by providing a user interface button that the seller may select. Selection of the button may cause a notification to be transmitted to the online marketplace service 106, which in turn transmits a notification to the multi-party negotiation system 108. Alternatively, selection of the button may cause a notification to be transmitted directly to the multi-party negotiation system 108.

The seller exhaustion module 306 determines whether triggering conditions related to the seller have been satisfied. In some embodiment, performance of a multi-party negotiation may be conditioned on the seller having adequately exhausted their ability to reduce the total value associated with an item listing. For example, a triggering condition may be based on the portion of the total value allocated to the seller having been reduced at least a threshold amount from an original value and/or the portion of the total value allocated to the seller being within a threshold amount of a cost value for the item.

To determine whether this type of triggering condition has been satisfied, the seller exhaustion module 306 accesses listing data associated with listings posted to the online marketplace. For example, the seller exhaustion module 306 may communicate with the online marketplace service 106 to access the listing data and/or access the listing data from the data storage 212, depending on the implemented embodiment. The listing data includes data identifying the current total value for an item listing, reductions that have been made to the total value, the portions of the total value allocated to the various parties, and the like.

The seller exhaustion module 306 may use the listing data to determine whether any of the triggering conditions have been met. For example, the seller exhaustion module 306 may determine an amount by which the portion of the total value allocated to the seller has been reduced from an original value. The seller exhaustion module 306 may then compare the determined reduced value to a threshold value. As another example, the seller exhaustion module 306 may determine a variance between the portion of the total cost allocated to the seller and a cost value associated with the item. The cost value may indicate the cost to the seller for purchasing the item or an average cost for purchasing the item at a retail rate. The seller exhaustion module 306 may then compare the determined variance to a threshold amount to determine whether the portion of the total value allocated to the seller is within a threshold amount of a cost value. This may indicate that the seller is no longer able to reduce their portion of the total value while remaining profitable.

The threshold comparison module 308 determines whether individual triggering conditions based on a target value are satisfied. These types of individual triggering conditions can be used to ensure that performing a multi-party negotiation can successfully reduce the final price to or near a target price. For example, a individual triggering condition may be based on the total value being within a threshold amount of a target value. The threshold amount may be based on an amount by which the total value can be expected to be further reduced through a multi-party negotiation. For example, the threshold amount may be based on a percentage of the portions that are allocated to the service provides that would allow the service providers to remain profitable. As a result, the multi-party negotiation system 108 will not perform a multi-party negotiation in situations in which the final price is unlikely to be reduced to or near a target value.

The threshold comparison module 308 may determine a target value based on an identified competitor price or a price offered by a seller. For example, the target value may be the competitor price or offered price, a value below the competitor price or offered price, or a value that is greater than the competitor price or offered price. To determine whether an individual triggering condition is satisfied, the threshold comparison module 308 may determine a variance between the total value for an item value and the target value. The threshold comparison module 308 may then compare the variance to the threshold amount to ensure that the variance is within the threshold amount, indicating that a multi-party negotiation could successfully reduce the total value to or near the final value.

The triggering module 310 triggers a multi-party negotiation in the event that a set of triggering conditions is determined to be satisfied. For example, the triggering module 310 may notify the negotiation management module 204 to initiate the multi-party negotiation. The triggering module 310 may provide the negotiation management module 204 with data related to the multi-party negotiation, such as by providing data identifying the listing, a determined target value, and the like.

FIG. 4 is a block diagram of a negotiation management module 204, according to some example embodiments. To avoid obscuring the inventive subject matter with unnecessary detail, various functional components (e.g., modules) that are not germane to conveying an understanding of the inventive subject matter have been omitted from FIG. 4. However, a skilled artisan will readily recognize that various additional functional components may be supported by the negotiation management module 204 to facilitate additional functionality that is not specifically described herein. Furthermore, the various functional modules depicted in FIG. 4 may reside on a single computing device or may be distributed across several computing devices in various arrangements such as those used in cloud-based architectures.

As shown, the negotiation management module 204 includes a reduced value determination module 402, a service provider identification module 404, a query management module 406 and a negotiation outcome module 408.

The reduced value determination module 402 determines reduced values to request from service providers to provide their services. The reduced value may be based on the variance between the total value and the target value. For example, the reduced value determination module 402 may determine the reduced values such that the total of the reduced values matches or exceeds the variance between eh total value and the target value.

In some embodiments, the reduced value determination module 402 may evenly distribute the variance across each service provider such that each service provider is asked to an equal reduction in value to provide their service. Alternatively, the reduced value determination module 402 may distribute the variance across each service provider proportionally based on the portion of the total value allocated to the service provider. In this type of embodiment, a service provider that is allocated a larger portion of the total value may be asked to reduce their portion by a larger value than another service provider that is allocated a smaller portion of the total value.

The service provider identification module 404 identifies service providers that may be queried to provide each service for a reduced value. In some cases, only a single service provider may be available to provide a particular service in relation to an item listing. For example, an online marketplace service 106 may have an existing relationship with a single service provider to provide the particular service, such as providing payment processing services for the items listing posted to the online marketplace. In some embodiments, however, multiple service providers may be available to provide a particular service in relation to an item listing. For example, an online marketplace service 106 may have an existing relationship with multiple service providers or allow any service provider to provide the particular service, such as payment processing, for the item listing posted to the online marketplace.

In either case, a service provider registry may be maintained that lists the service providers available to provide each service. For example, the service provider registry may be maintained in the data storage 212. The service provider identification module 404 may access the service provider registry from the data storage 212 to identify the available service providers. The service provider registry may maintain contact information for communicating with the service providers, such as by including phone numbers, email address, and the like.

The query management module 406 manages the process of querying the service providers. This includes generating queries, transmitting the queries to the service providers, receiving query responses from the service providers, and/or transmitting subsequent queries. A query may be any type of communication message, such as an email, text message, Short Message Service (SMS) message, in-app message, and the like. A query may identify a reduced value at which the service provider is being requested to provide their service and/or prompt the service provider to enter a reduced value at which the service provider is willing to provide the service. A query may enable the service provider to accept or deny providing the service at a reduced value, such as by including user interface elements (e.g., buttons) corresponding to each response. Accordingly, a service provider may select from the presented user interface elements to provide the corresponding response. For example, the service provider may select a presented interface element to accept the request, indicating that the service provider is willing to provide the service for the reduced value. Alternatively, the service provider may select another user interface element to deny the request, indicating that the service provider is not willing to provide the service for the reduced value. In some embodiments, the query may enable a service provider to submit a counteroffer, such as by entering an alternate reduced value that the service provider is willing to accept for providing the service. Accordingly, a service provider may enter an alternate reduced value that is higher than the reduced value included in the query received from the multi-party negotiation system 108.

The query management module 406 also receives query response from the service providers. A query response is a message indicating the service providers response to a query, such as whether the service provider accepted or denied to the request to provide the service for a reduced value. A query response may also include a reduced value provided by the service provider to provide the service, such as a reduced value provided by a service provider that was prompted to bid on providing the service or a reduced value provided by a service provider as a counteroffer. The query management module 406 communicates with the negotiation outcome module 408 to provide the negotiation outcome module 408 with data indicating the responses provided by the queried service providers.

The negotiation outcome module 408 uses the data received from the query management module 406 to determine an outcome of multi-party negotiation, as well operations to perform based on the determined outcome. For example, the negotiation outcome module 408 may determine that the outcome is successful in reducing the total value, unsuccessful in reducing the total value, or that additional negotiation should be performed.

To determine the outcome of a multi-party negotiation, the negotiation outcome module 408 determines a reduced total value that can be achieved based on the responses provided by the service providers and compares the reduced total value to the target value. For example, the negotiation outcome module 408 uses the reduced values that were accepted by the service providers, if any, to calculate the reduced total value. This may include selecting a reduced value that is lowest from multiple service providers that provided bids to offer a service.

The negotiation outcome module 408 compares the reduced total value to the target value to determine whether the target value can be met (e.g., the reduced total value is at or below the target value) based on the responses received from the service providers. If the comparison indicates that the target value can be met, the negotiation outcome module 408 determines that the multi-party negotiation was successful. The negotiation outcome module 408 may then notify the other modules of the multi-party negotiation system 108 that the multi-party negotiation was successful, as well as provide the reduced total value and the portions of the reduced total value to be allocated to each service provider.

If the comparison indicates that the target value cannot be met (e.g., the reduced total value is greater than the target value), the negotiation outcome module 408 determines that the multi-party negotiation was unsuccessful. In this situation the negotiation outcome module 408 may notify the other modules of the multi-party negotiation system 108 that the multi-party negotiation was unsuccessful.

Alternatively, the negotiation outcome module 408 may also determine whether additional negotiations should be performed in an attempt to meet the total value. For example, the negotiation outcome module 408 may determine a variance between the reduced total value and the target value, and then determine whether the variance is less than a threshold variance. If the negotiation outcome module 408 determines that the variance is less than the threshold variance, indicating that the reduced total value is close to the target value, the negotiation outcome module 408 may instruct the other modules of the negotiation management module 204 to continue the multi-party negotiation process. For example, the negotiation outcome module 408 may instruction the reduced value determination module 402 to determine a reduced value that one or more of the services providers would have to accept to meet the target value, instruct the query management module 406 to transmit queries, and the like.

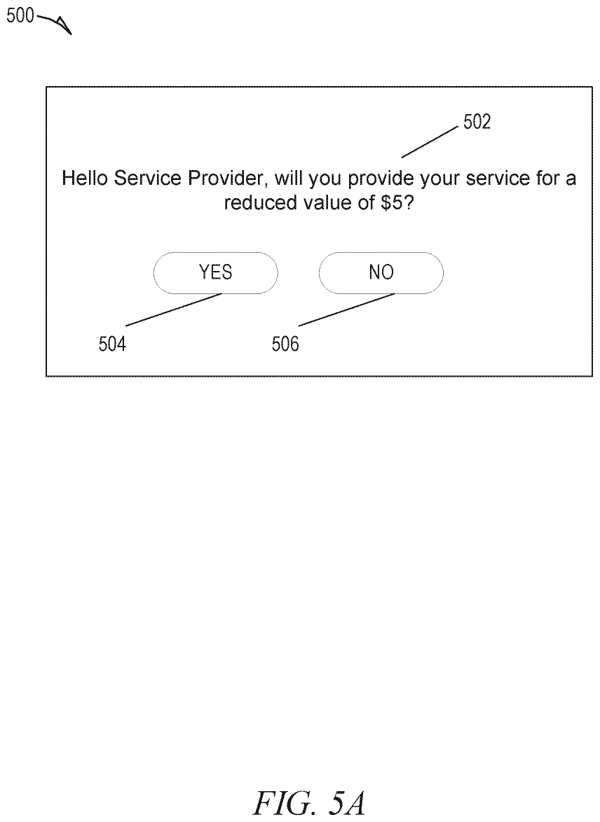

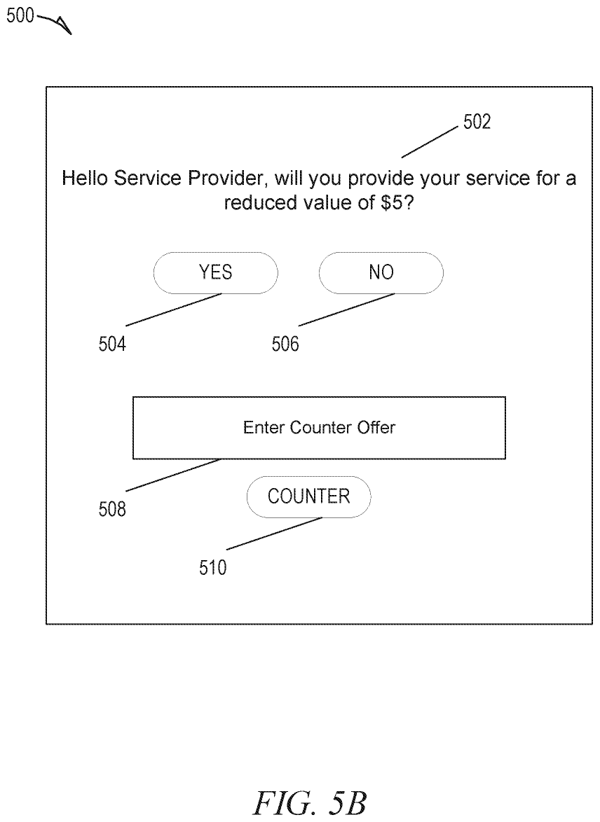

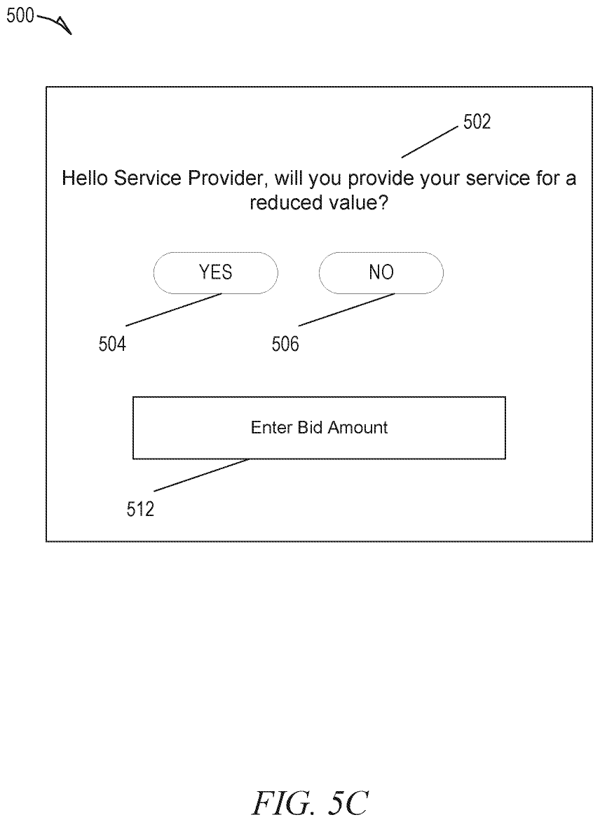

FIGS. 5A-5C show examples of queries 500 transmitted to service providers, according to some example embodiments. As shown in FIG. 5A, the query 500 includes a message 502 requesting that the service provider provide the service for a reduced value of five dollars. The query 500 includes two user interface elements (e.g., accept button 504, deny button 506) that enable the service provider to respond to the query. For example, the service provider may select the accept button 504 to accept the request to provide the service for the reduced value of five dollars. Alternatively, the service provider may select the deny button 506 to deny the request to provide the service for the reduced value of five dollars. Selection of the accept button 504 or the deny button 506 may cause a query response indicating the service provider's selected response to be sent to the multi-party negotiation system 108.

In FIG. 5B, the query 500 further enables a service provider to provide a counteroffer to the multi-party negotiation system 108. For example, as show, the query 500 includes a counteroffer text field 508 and a counteroffer button 510. A service provider may use the counteroffer text field 508 to enter a counteroffer value. For example, a service provider that is not willing to provide the service for five dollars may use the counteroffer text field 508 to provide a counteroffer value, such as six dollars, at which the service provider is willing to provide the service. Selection of the counteroffer button 510 causes a query response including the counteroffer value entered into the counteroffer text field 508 to be sent to the multi-party negotiation system 108. The multi-party negotiation system 108 may then select whether to accept or deny the counteroffer submitted by the service provider.

FIG. 5C shows a query 500 that requests that the service provider provide the service for a reduced value, but in contrast to the query 500 shown in FIGS. 5A and 5B, the query shown in FIG. 5C prompts the service provider to enter a reduced value (e.g., bid) rather identifying a reduced value. This type of query 500 may be used when multiple service providers are queried to provide the same service. Each queried service provider may provide a reduced value at which the service provider is willing to perform the service, and the multi-party negotiation system 108 may select the service provider that provided the lowest reduced value. To provide a reduced value, the service provider may enter the reduced value into the bid amount text field 512 and select the accept button 504, causing a query response including the reduced value entered into the bid amount text field 512 to be sent to the multi-party negotiation system 108. Alternatively, the service provider may select the deny button 506 to deny the request to provide the service for a reduced value.

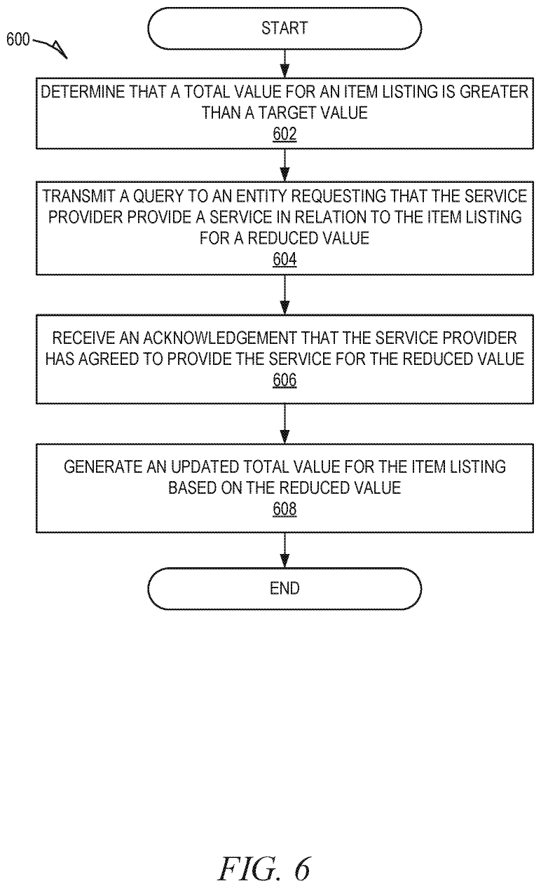

FIG. 6 is a flowchart showing a method 600 of multi-party negotiation in an online marketplace, according to some example embodiments. The method 600 may be embodied in computer readable instructions for execution by one or more processors such that the operations of the method 600 may be performed in part or in whole by the multi-party negotiation system 108; accordingly, the method 600 is described below by way of example with reference thereto. However, it shall be appreciated that at least some of the operations of the method 600 may be deployed on various other hardware configurations and the method 600 is not intended to be limited to the multi-party negotiation system 108.

At operation 602, the negotiation triggering module 202 determines that a total value for an item listing is greater than a target value. The target value may be based on a competitor price offered for a same or similar item, or an offered value submitted for the item listing that was rejected by the seller.

At operation 604, the negotiation management module 204 transmits a query to a service provider requesting that the service provider provide a service in relation to the item listing for a reduced value. This may include identifying the service provider that can provide the service in relation to the item listing, determining the reduced value to be requested from the service provider, and transmitting the query to the service provider.

A query may be any type of communication message, such as an email, text message, Short Message Service (SMS) message, in-app message, and the like. A query may identify the reduced value and/or prompt the service provider to enter a reduced value which the service provider is willing to accept to provide the service. Further, a query may enable the service provider to accept or deny the request, such as by including user interface elements which the service provider may select to choose from either option. For example, the service provider may select to accept the request, indicating that the service provider is willing to provide the service for the reduced value. Alternatively, the service provider may select to deny the request, indicating that the service provider is not willing to provide the service for the reduced value.

In some embodiments, the query may enable a service provider to provide a counteroffer, such as by entering an alternate reduced value that the service provider is willing to accept (e.g., an alternate reduced value that is higher than the reduced value included in the query).

At operation 606, the negotiation management module 204 receives an acknowledgement that the service provider has agreed to provide the service for the reduced value.

At operation 608, the negotiation management module 204 generates an updated total value for the item listing based on the reduced value. For example, the portion of the reduced total value allocated to the service provider is based on the reduced value at which the service provider agreed to provide the service. This allows the original total value to be reduced to a reduced total value without affecting the value allocated to the seller. That is, the portion of the reduces total value allocated to the seller is the same as the portion of the original total value that was allocated to the seller.

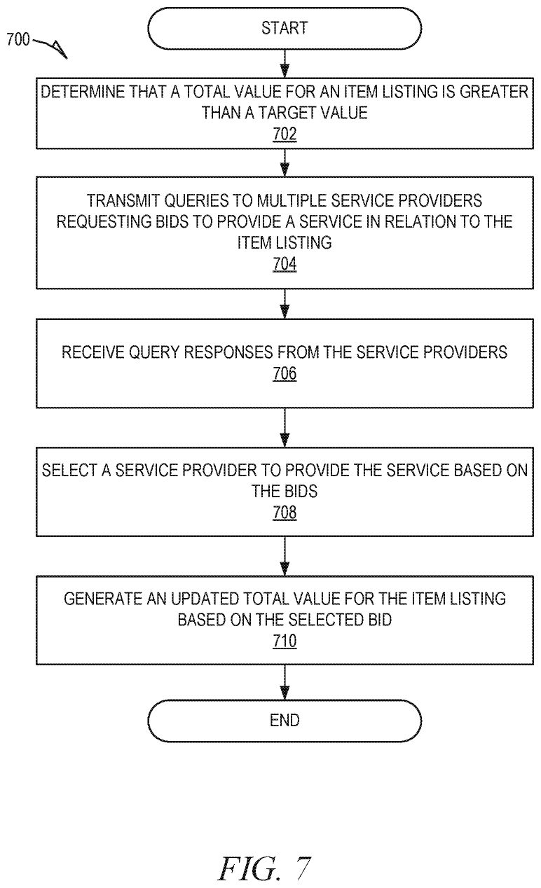

FIG. 7 is a flowchart showing a method 700 of multi-party negotiation in an online marketplace, according to some example embodiments. The method 700 may be embodied in computer readable instructions for execution by one or more processors such that the operations of the method 700 may be performed in part or in whole by the multi-party negotiation system 108; accordingly, the method 700 is described below by way of example with reference thereto. However, it shall be appreciated that at least some of the operations of the method 700 may be deployed on various other hardware configurations and the method 700 is not intended to be limited to the multi-party negotiation system 108.

At operation 702, the negotiation triggering module 202 determines that a total value for an item listing is greater than a target value. The target value may be based on a competitor price offered for a same or similar item, or an offered value submitted for the item listing that was rejected by the seller.

At operation 704, the negotiation management module 204 transmits queries to multiple service providers requesting bids to provide bids to provide a service in relation to the item listing. Multiple service providers may provide a service, such as a shipping logistic service and/or a payment processing service. The negotiation management module 204 may identify a set of service providers that provide the service and transmit queries to each identified service provider.

A query may be any type of communication message, such as an email, text message, Short Message Service (SMS) message, in-app message, and the like. A query may prompt a service provider to enter a reduced value (e.g., bid) which the service provider is willing to accept to provide the service. Further, a query may enable the service provider to accept or deny the request, such as by including user interface elements which the service provider may select to choose from either option.

At operation 706, the negotiation management module 204 receives query responses from the service providers. Each query response may indicate whether a service provider has selected to accept or deny the request to provide a bid, as well as identify a bid amount (e.g., reduced value) if the service provider has accepted the request.

At operation 708, the negotiation management module 204 selects a service provider to provide the service based on the bids. For example, the negotiation management module 204 may select a service provider that provided the lowest bid (e.g., the lowest reduced value).

At operation 710, the negotiation management module 204 generates an updated total value for the item listing based on the selected bid. That is, the negotiation management module 204 generates the updated total value for the item listing based on the reduced value that was provided by the selected service provider. The portion of the reduced total value allocated to the service provider is based on the reduced value at which the service provider agreed to provide the service. This allows the original total value to be reduced to a reduced total value without affecting the value allocated to the seller. That is, the portion of the reduces total value allocated to the seller is the same as the portion of the original total value that was allocated to the seller.

### Software Architecture

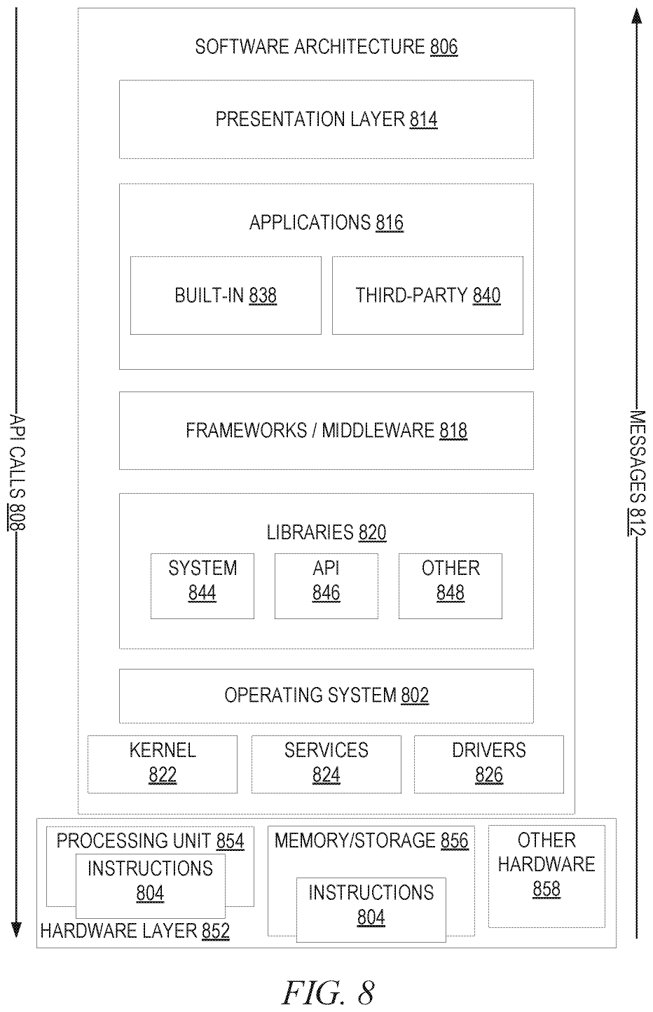

FIG. 8 is a block diagram illustrating an example software architecture 806, which may be used in conjunction with various hardware architectures herein described. FIG. 8 is a non-limiting example of a software architecture 806 and it will be appreciated that many other architectures may be implemented to facilitate the functionality described herein. The software architecture 806 may execute on hardware such as machine 900 of FIG. 9 that includes, among other things, processors 904, memory 914, and (input/output) I/O components 918. A representative hardware layer 852 is illustrated and can represent, for example, the machine 900 of FIG. 9. The representative hardware layer 852 includes a processing unit 854 having associated executable instructions 804. Executable instructions 804 represent the executable instructions of the software architecture 806, including implementation of the methods, components, and so forth described herein. The hardware layer 852 also includes memory and/or storage modules 856, which also have executable instructions 804. The hardware layer 852 may also comprise other hardware 858.

In the example architecture of FIG. 8, the software architecture 806 may be conceptualized as a stack of layers where each layer provides particular functionality. For example, the software architecture 806 may include layers such as an operating system 802, libraries 820, frameworks/middleware 818, applications 816, and a presentation layer 814. Operationally, the applications 816 and/or other components within the layers may invoke Application Programming Interface (API) calls 808 through the software stack and receive a response such as messages 812 in response to the API calls 808. The layers illustrated are representative in nature and not all software architectures have all layers. For example, some mobile or special purpose operating systems may not provide a frameworks/middleware 818, while others may provide such a layer. Other software architectures may include additional or different layers.

The operating system 802 may manage hardware resources and provide common services. The operating system 802 may include, for example, a kernel 822, services 824, and drivers 826. The kernel 822 may act as an abstraction layer between the hardware and the other software layers. For example, the kernel 822 may be responsible for memory management, processor management (e.g., scheduling), component management, networking, security settings, and so on. The services 824 may provide other common services for the other software layers. The drivers 826 are responsible for controlling or interfacing with the underlying hardware. For instance, the drivers 826 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 820 provide a common infrastructure that is used by the applications 816 and/or other components and/or layers. The libraries 820 provide functionality that allows other software components to perform tasks in an easier fashion than to interface directly with the underlying operating system 802 functionality (e.g., kernel 822, services 824, and/or drivers 826). The libraries 820 may include system libraries 844 (e.g., C standard library) that may provide functions such as memory allocation functions, string manipulation functions, mathematical functions, and the like. In addition, the libraries 820 may include API libraries 846 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 820 may also include a wide variety of other libraries 848 to provide many other APIs to the applications 816 and other software components/modules.

The frameworks/middleware 818 (also sometimes referred to as middleware) provide a higher-level common infrastructure that may be used by the applications 816 and/or other software components/modules. For example, the frameworks/middleware 818 may provide various graphical user interface (GUI) functions, high-level resource management, high-level location services, and so forth. The frameworks/middleware 818 may provide a broad spectrum of other APIs that may be used by the applications 816 and/or other software components/modules, some of which may be specific to a particular operating system 802 or platform.

The applications 816 include built-in applications 838 and/or third-party applications 840. Examples of representative built-in applications 838 may include, but are not limited to, a contacts application, a browser application, a book reader application, a location application, a media application, a messaging application, and/or a game application. Third-party applications 840 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 840 may invoke the API calls 808 provided by the mobile operating system (such as operating system 802) to facilitate functionality described herein.

The applications 816 may use built in operating system functions (e.g., kernel 822, services 824, and/or drivers 826), libraries 820, and frameworks/middleware 818 to create UIs to interact with users of the system. Alternatively, or additionally, in some systems, interactions with a user may occur through a presentation layer, such as presentation layer 814. In these systems, the application/component “logic” can be separated from the aspects of the application/component that interact with a user.

Win FIG. 9 is a block diagram illustrating components of a machine 900, according to some example embodiments, able to read instructions 804 from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 910 (e.g., software, a program, an application, an applet, an app, or other executable code) for causing the machine 900 to perform any one or more of the methodologies discussed herein may be executed. As such, the instructions 910 may be used to implement modules or components described herein. The instructions 910 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 900 capable of executing the instructions 910, sequentially or otherwise, that specify actions to be taken by machine 900. Further, while only a single machine 900 is illustrated, the term “machine” shall also be taken to include a collection of machines that individually or jointly execute the instructions 910 to perform any one or more of the methodologies discussed herein.

The machine 900 may include processors 904, memory/storage 906, and I/O components 918, which may be configured to communicate with each other such as via a bus 902. The memory/storage 906 may include a memory 914, such as a main memory, or other memory storage, and a storage unit 916, both accessible to the processors 904 (e.g., processor 909, processor 912) such as via the bus 902. The storage unit 916 and memory 914 store the instructions 910 embodying any one or more of the methodologies or functions described herein. The instructions 910 may also reside, completely or partially, within the memory 914, within the storage unit 916, within at least one of the processors 904 (e.g., within the processor's cache memory), or any suitable combination thereof, during execution thereof by the machine 900. Accordingly, the memory 914, the storage unit 916, and the memory of processors 904 are examples of machine-readable media.

The I/O components 918 may include a wide variety of components to receive input, provide output, produce output, transmit information, exchange information, capture measurements, and so on. The specific I/O components 918 that are included in a particular machine 900 will depend on the type of machine. For example, portable machines such as mobile phones will likely include a touch input device or other such input mechanisms, while a headless server machine will likely not include such a touch input device. It will be appreciated that the I/O components 918 may include many other components that are not shown in FIG. 9. The I/O components 918 are grouped according to functionality merely for simplifying the following discussion and the grouping is in no way limiting. In various example embodiments, the I/O components 918 may include output components 926 and input components 928. The output components 926 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 928 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 918 may include biometric components 930, motion components 934, environmental components 936, or position components 938 among a wide array of other components. For example, the biometric components 930 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 934 may include acceleration sensor components (e.g., accelerometer), gravitation sensor components, rotation sensor components (e.g., gyroscope), and so forth. The environmental components 936 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 938 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 918 may include communication components 940 operable to couple the machine 900 to a network 932 or devices 920 via coupling 924 and coupling 922, respectively. For example, the communication components 940 may include a network interface component or other suitable device to interface with the network 932. In further examples, communication components 940 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 920 may be another machine or any of a wide variety of peripheral devices (e.g., a peripheral device coupled via a USB).

Moreover, the communication components 940 may detect identifiers or include components operable to detect identifiers. For example, the communication components 940 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra. Code, UCC RSS-2D bar code, and other optical codes), or acoustic detection components (e.g., microphones to identify tagged audio signals). In addition, a variety of information may be derived via the communication components 940, such as, location via Internet Protocol (IP) geo-location, location via Wi-Fi® signal triangulation, location via detecting a NEC beacon signal that may indicate a particular location, and so forth.

### Glossary

“CARRIER SIGNAL” in this context refers to any intangible medium that is capable of storing, encoding, or carrying instructions 910 for execution by the machine 900, and includes digital or analog communications signals or other intangible medium to facilitate communication of such instructions 910. Instructions 910 may be transmitted or received over the network 932 using a transmission medium via a network interface device and using any one of a number of well-known transfer protocols.

“CLIENT DEVICE” in this context refers to any machine 900 that interfaces to a communications network 932 to obtain resources from one or more server systems or other client devices. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 932.

“COMMUNICATIONS NETWORK” in this context refers to one or more portions of a network 932 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 932 or a portion of a network 932 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 910 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 910. The term “machine-readable medium” shall also be taken to include any medium, or combination of multiple media, that is capable of storing instructions 910 (e.g., code) for execution by a machine 900, such that the instructions 910, when executed by one or more processors 904 of the machine 900, cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 904) may be configured by software (e.g., an application 816 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 904 or other programmable processor 904. Once configured by such software, hardware components become specific machines 900 (or specific components of a machine 900) uniquely tailored to perform the configured functions and are no longer general-purpose processors 904. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 904 configured by software to become a special-purpose processor, the general-purpose processor 904 may be configured as respectively different special-purpose processors (e.g., comprising different hardware components) at different times. Software accordingly configures a particular processor or processors 904, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 902) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 904 that are temporarily configured (e.g., by software) or permanently configured to perform the relevant operations. Whether temporarily or permanently configured, such processors 904 may constitute processor-implemented components that operate to perform one or more operations or functions described herein. As used herein, “processor-implemented component” refers to a hardware component implemented using one or more processors 904. Similarly, the methods described herein may be at least partially processor-implemented, with a particular processor or processors 904 being an example of hardware. For example, at least some of the operations of a method may be performed by one or more processors 904 or processor-implemented components. Moreover, the one or more processors 904 may also operate to support performance of the relevant operations in a “cloud computing” environment or as a “software as a service” (SaaS). For example, at least some of the operations may be performed by a group of computers (as examples of machines 900 including processors 904), with these operations being accessible via a network 932 (e.g., the Internet) and via one or more appropriate interfaces (e.g., an API). The performance of certain of the operations may be distributed among the processors 904, not only residing within a single machine 900, but deployed across a number of machines 900. In some example embodiments, the processors 904 or processor-implemented components may be located in a single geographic location (e.g., within a home environment, an office environment, or a server farm). In other example embodiments, the processors 904 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 900. A processor 904 may be, for example, a central processing unit (CPU), a reduced instruction set computing (RISC) processor, a complex instruction set computing (CISC) processor; a graphics processing unit (GPU), a digital signal processor (DSP), an ASIC, a radio-frequency integrated circuit (RFIC) or any combination thereof. A processor may further be a multi-core processor having two or more independent processors 904 (sometimes referred to as “cores”) that may execute instructions 910 contemporaneously.

What is claimed is:

1. A method comprising:
determining that a total value for an item listing is greater than a target value for the item listing, the total value including a first portion of the total value that is allocated to a first service provider providing a first service related to the item listing;
transmitting a first query to the first service provider associated with the first portion of the total value, the first query requesting that the first service provider provide the first service for a reduced value; and
in response to receiving an acknowledgement that the first service provider has agreed to provide the first service for the reduced value, generating an updated total value for the item listing based on the reduced value, the updated total value being no greater than the target value.

2. The method of claim 1, further comprising:
transmitting a second query to a second service provider associated with a second portion of the total value, the second service provider providing a second service related to the item listing, the second query requesting that the second service provider provide the second service for a second reduced value; and
receiving an acknowledgement that the second service provider has agreed to provide the second service for the second reduced value; the updated total value being further generated based on the second reduced value.

3. The method of claim 1, wherein the first service includes one or more of: handling, shipping, marketplace management, and payment management.

4. The method of claim 1, wherein the total value for the item listing includes a second portion associated with an account that posted the item listing, the second portion remaining unchanged in the updated total value.

5. The method of claim 1, further comprising:
transmitting a second query to a second service provider that provides the first service, the second query requesting that the second service provider provide the first service for a reduced value.

6. The method of claim 1, wherein the target value is an offered value associated with a rejected offer for the item listing.

7. The method of claim 1, wherein the target value is a competitor price for purchasing an item being offered by the item listing.

8. A system comprising:
one or more computer processors; and
one or more computer-readable mediums storing instructions that, when executed by the one or more computer processors, cause the system to perform operations comprising:
determining that a total value for an item listing is greater than a target value for the item listing, the total value including a first portion of the total value that is allocated to a first service provider providing a first service related to the item listing;
transmitting a first query to the first service provider associated with the first portion of the total value, the first query requesting that the first service provider provide the first service for a reduced value; and
in response to receiving an acknowledgement that the first service provider has agreed to provide the first service for the reduced value, generating an updated total value for the item listing based on the reduced value, the updated total value being no greater than the target value.

9. The system of claim 8, the operations further comprising:
transmitting a second query to a second service provider associated with a second portion of the total value, the second service provider providing a second service related to the item listing, the second query requesting that the second service provider provide the second service for a second reduced value; and
receiving an acknowledgement that the second service provider has agreed to provide the second service for the second reduced value, the updated total value being further generated based on the second reduced value.

10. The system of claim 8, wherein the first service includes handling, shipping, marketplace management, payment management, or some combination thereof.

11. The system of claim 8, wherein the total value for the item listing includes a second portion associated with an account that posted the item listing, the second portion remaining unchanged in the updated total value.

12. The system of claim 8, the operations further comprising:
transmitting a second query to a second service provider that provides the first service, the second query requesting that the second service provider provide the first service for a reduced value.

13. The system of claim 8, wherein the target value is an offered value associated with a rejected offer for the item listing.

14. The system of claim 8, wherein the target value is a competitor price for purchasing an item being offered by the item listing.

15. A machine-readable medium storing instructions that, when executed by one or more computer processors of one or more computing devices, cause the one or more computing devices to perform operations comprising:
determining that a total value for an item listing is greater than a target value for the item listing, the total value including a first portion of the total value that is allocated to a first service provider providing a first service related to the item listing;
transmitting a first query to the first service provider associated with the first portion of the total value, the first query requesting that the first service provider provide the first service for a reduced value; and
in response to receiving an acknowledgement that the first service provider has agreed to provide the first service for the reduced value, generating an updated total value for the item listing based on the reduced value, the updated total value being no greater than the target value.

16. The machine-readable medium of claim 15, the operations further comprising:
transmitting a second query to a second service provider associated with a second portion of the total value, the second service provider providing a second service related to the item listing, the second query requesting that the second service provider provide the second service for a second reduced value; and
receiving an acknowledgement that the second service provider has agreed to provide the second service for the second reduced value; the updated total value being further generated based on the second reduced value.

17. The machine-readable medium of claim 15, wherein the first service includes one or more of: handling, shipping, marketplace management, and payment management.

18. The machine-readable medium of claim 15, wherein the total value for the item listing includes a second portion associated with an account that posted the item listing, the second portion remaining unchanged in the updated total value.

19. The machine-readable medium of claim 15, the operations further comprising:
transmitting a second query to a second service provider that provides the first service, the second query requesting that the second service provider provide the first service for a reduced value.

20. The machine-readable medium of claim 15, wherein the target value is an offered value associated with a rejected offer for the item listing.
